(19) United States
(12) Patent Application Publication
(10) Pub. No.: US 2023/0274214 A1
(43) Pub. Date: Aug. 31, 2023

(54) MULTI-LEVEL GRAPH EMBEDDING

(71) Applicant: Microsoft Technology Licensing, LLC, Redmond, WA (US)

(72) Inventors: Vipindeep VANGALA, Hyderabad (IN); Rajeev GUPTA, Hyderabad (IN); Madhusudhanan KRISHNAMOORTHY, Srivilliputtur (IN); Amrit SAHU, Bhubaneswar (IN); Rohit GUPTA, Alwar (IN)

(73) Assignee: Microsoft Technology Licensing, LLC, Redmond, WA (US)

(21) Appl. No.: 17/681,418

(22) Filed: Feb. 25, 2022

(51) Int. Cl. G06Q 10/06; G06F 16/903

(52) U.S. Cl. CPC G06Q 10/067; G06F 16/90335

(57) ABSTRACT

A method for providing graph data is described. A request for graph data based on a data graph is received, the data graph having i) nodes representing entities associated with an enterprise organization, and ii) edges between nodes representing relationships among the entities. A search embedding corresponding to the request is generated. Embeddings from a set of embeddings that are adjacent to the search embedding are identified, wherein the set of embeddings represent the data graph. Graph data corresponding to the identified embeddings is provided in response to the request.

### BACKGROUND

Enterprise organizations may manage large amounts of data for entities associated with the organization, such as various users (e.g., employees), emails sent by the users, documents generated by the users, meetings attended by the users, etc. These entities may have relationships among themselves, for example, a first user (e.g., a first entity) may have an authorship relationship with a document that they generated (e.g., a second entity). Further relationships may be created or modified when the document is shared with a second user of the organization, included in an email message, or referenced within a meeting invite. Knowledge of these relationships may be leveraged to recommend relevant entities to a user when performing some tasks, such as sending an email (e.g., recommendations for documents to be attached) or composing a meeting invite (e.g., recommendations for users to invite). Data for the entities and relationships may be stored as a data graph having nodes representing the entities and edges between nodes representing the relationships. However, techniques such as “graph walks” may be either time-consuming or have high processing power requirements to provide a recommendation in real-time.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure are directed to providing graph data.

In one aspect, a method of providing graph data is provided. A request for graph data based on a data graph is received, the data graph having i) nodes representing entities associated with an enterprise organization, and ii) edges between nodes representing relationships among the entities. A search embedding corresponding to the request is generated. Embeddings from a set of embeddings that are adjacent to the search embedding are identified, wherein the set of embeddings represent the data graph. Graph data corresponding to the identified embeddings is provided in response to the request.

In another aspect, a system for providing graph data is provided. The system includes a node processor configured to receive requests for graph data, where the node processor is configured to: generate a first sub-graph of a data graph, the data graph having i) nodes representing entities associated with an enterprise organization, and ii) edges between nodes representing relationships among the entities; generate a first set of embeddings using the first sub-graph, wherein embeddings of the first set of embedding correspond to respective nodes of the first sub-graph; generate a second sub-graph of the data graph having at least some different nodes from the first sub-graph; generate a second set of embeddings using the second sub-graph, wherein embeddings of the second set of embeddings correspond to respective nodes of the second sub-graph and at least one node of the data graph corresponds to embeddings from the first set of embeddings and embeddings from the second set of embeddings; and respond to requests for graph data based on a data graph using one of the first set of embeddings and the second set of embeddings to identify adjacent nodes of the data graph as the graph data.

In yet another aspect, method for providing graph data is provided. A first sub-graph of a data graph is generated, the data graph having i) nodes representing entities associated with an enterprise organization, and ii) edges between nodes representing relationships among the entities. A first set of embeddings is generated using the first sub-graph, wherein embeddings of the first set of embedding correspond to respective nodes of the first sub-graph. A second sub-graph of the data graph is generated, the second sub-graph having at least some different nodes from the first sub-graph. A second set of embeddings is generated using the second sub-graph, wherein embeddings of the second set of embeddings correspond to respective nodes of the second sub-graph and at least one node of the data graph corresponds to embeddings from the first set of embeddings and embeddings from the second set of embeddings. Requests for graph data based on the data graph are responded to using one of the first set of embeddings and the second set of embeddings to identify adjacent nodes of the data graph as the graph data.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS/FIGURES

Non-limiting and non-exhaustive examples are described with reference to the following Figures.

FIG. 1 shows a block diagram of an example of a data graph processing system that is configured to provide graph data, according to an example embodiment.

FIG. 2 shows a diagram of an example of a data graph, according to an example embodiment.

FIG. 3 shows a diagram of an example of a graphical user interface for providing graph data, according to an example embodiment.

FIG. 4 shows a diagram of an example method for providing graph data, according to an example embodiment.

FIG. 5 shows a flowchart of another example method of providing graph data, according to an example embodiment.

FIG. 6 is a block diagram illustrating example physical components of a computing device with which aspects of the disclosure may be practiced.

FIGS. 7 and 8 are simplified block diagrams of a mobile computing device with which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Data graphs often contain information that improves searches, predictions, recommendations, entity-entity lookups, clustering, and other processing scenarios, but efficient processing of the data graphs (e.g., using a graph walk algorithm) to obtain useful graph data (e.g., nodes and/or edges) in real-time or near real-time is challenging. In examples described herein, embeddings are generated for data graphs where the embeddings represent semantics of entities within an enterprise organization. The embeddings are generally implemented in a relatively low dimension vector space or feature space, for example, as a vector having ten, twenty, one hundred elements, or another suitable number of elements to allow for more efficient processing as compared to graph walks. Moreover, in contrast to systems that use embeddings based only on the content (e.g., text) for an entity, examples described herein utilize a node processor that generates embeddings based on content, relationships, and/or both content and relationships among the entities.

In examples, the node processor generates a set of embeddings for each node where the embeddings are created at different levels or slices of the full data graph for the enterprise organization. Even though embeddings are generated for different entity types (e.g., documents, users, emails, etc.), in examples, the embeddings are implemented as vectors having a same number of elements so that processing (e.g., comparing) of different entity types or same entity types is readily performed, for example, using a distance metric between the embeddings.

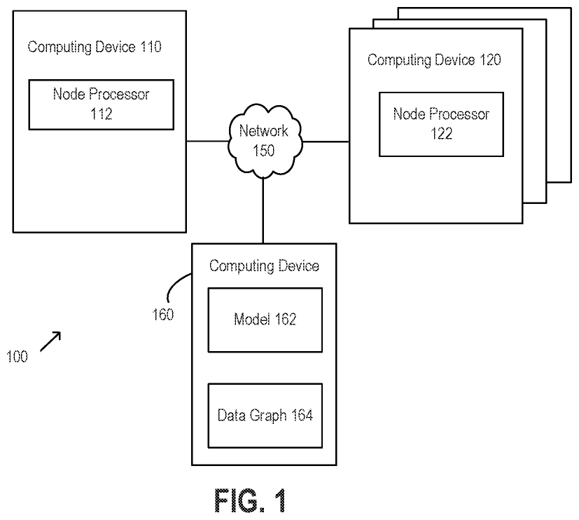

In accordance with embodiments of the present disclosure, FIG. 1 depicts an example of a data graph processing system 100 that is configured to provide graph data. The data graph processing system 100 includes a computing device 110 and a computing device 120. In some embodiments, the data graph processing system 100 also includes a data store 160. A network 150 communicatively couples computing device 110, computing device 120, and data store 160. The network 150 may comprise one or more networks such as local area networks (LANs), wide area networks (WANs), enterprise networks, the Internet, etc., and may include one or more of wired, wireless, and/or optical portions.

Computing device 110 may be any type of computing device, including a mobile computer or mobile computing device (e.g., a Microsoft® Surface® device, a laptop computer, a notebook computer, a tablet computer such as an Apple iPad™, a netbook, etc.), or a stationary computing device such as a desktop computer or PC (personal computer). Computing device 110 may be configured to execute one or more software applications (or “applications”) and/or services and/or manage hardware resources (e.g., processors, memory, etc.), which may be utilized by users of the computing device 110 and/or the computing device 120. The computing device 120 may include one or more server devices, distributed computing platforms, cloud platform devices, and/or other computing devices. For ease of discussion, the description herein refers to a single computing device 120, but features and examples of the computing device 120 are applicable to two, three, or more computing devices 120.

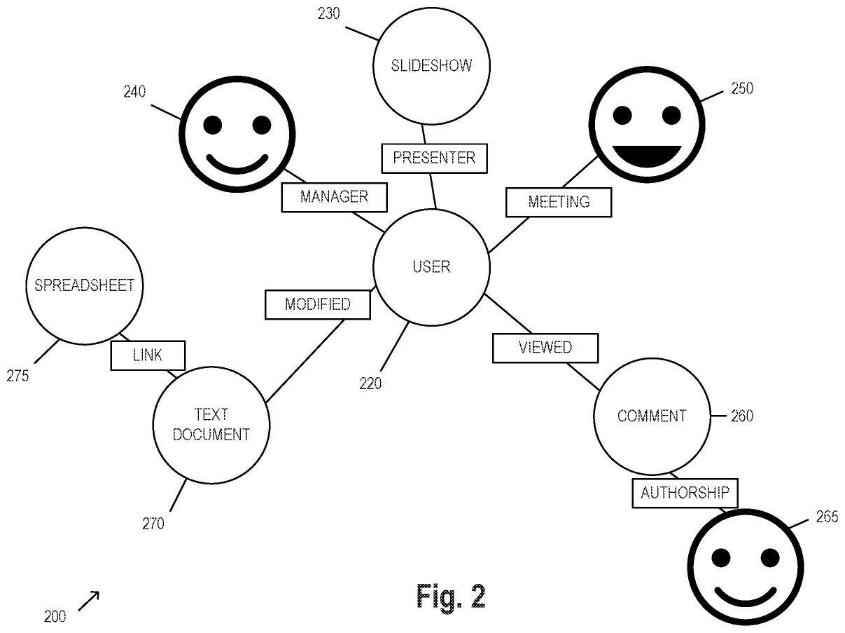

The computing device 110 includes a node processor 112 that generates embeddings for a data graph and provides graph data. In an embodiment, the node processor 112 is configured to utilize a neural network model, such as a neural network model 162, to generate embeddings for data graph 164, described below. Generally, the data graph 164 is a representation of entities associated with an organization along with relationships among the entities. In some examples, the data graph 164 generally corresponds to the data graph 200 (FIG. 2) and may be stored as one or more data structures, database entries, or other suitable format. The computing device 120 includes a node processor 122, which may be the same, or similar to, the node processor 112.

In accordance with examples of the present disclosure, the node processor 112 may receive a request for graph data based on the data graph 164 or data graph 200 (FIG. 2). In various examples, the request may be one of many different types, for example, a request for candidate generation (e.g., files to be attached to an email), a request for relevant entities for a search (e.g., files related to a topic), a request for automatic suggestions or recommendations of entities (e.g., users to be included on an email or meeting request), a request for synthesis of entities, or other suitable request types. The graph data provided in response to a request may include embeddings, nodes of the data graph 200, edges of the data graph 200, documents or files corresponding to the nodes or edges, or identifiers (e.g., unique identifiers, links, file locations, etc.) that correspond to the nodes and/or edges. In other words, the request may be referred to as a request for embeddings, nodes, edges, documents, files, users, meetings, etc. that are related to a search query.

The node processor 112 may extract information from the request, such as search terms (e.g., “4th quarter revenue”) and generate a search embedding that represents the search. In some examples, the node processor 112 provides the information to the neural network model 162 executing at a neural processing unit. The neural network model 162 may then generate the search embedding. Because the neural processing unit is specifically designed and/or programmed to process neural network tasks, the consumption of resources, such as power and/or computing cycles, is less than the consumption would be if a central processing unit were used. After generation of the search embedding, the node processor 112 identifies embeddings from a set of embeddings that are adjacent to the search embedding. For example, the node processor 112 identifies embeddings within the set of embeddings that have a low Euclidean distance relative to the search embedding. The node processor 112 may provide graph data corresponding to the identified embeddings in response to the received request. For example, the node processor 112 may provide nodes, edges, or other suitable information associated therewith (e.g., documents, emails, user information, etc.) as the graph data. In some examples, the node processor 112 provides ranked graph data that includes two, three, or more nodes, edges, files, emails, or other suitable information arranged by distance (e.g., smallest distance to largest distance). The graph data may include different types of data, for example: three files and two emails; two meetings, four users, and two spreadsheets; two files and four relationship types, etc.

The data store 160 is configured to store data, for example, the neural network model 162 and data graph 164. In various embodiments, the data store 160 is a network server, cloud server, network attached storage (“NAS”) device, or other suitable computing device. Data store 160 may include one or more of any type of storage mechanism, including a magnetic disc (e.g., in a hard disk drive), an optical disc (e.g., in an optical disk drive), a magnetic tape (e.g., in a tape drive), a memory device such as a random access memory (RAM) device, a read-only memory (ROM) device, etc., and/or any other suitable type of storage medium. Although only one instance of the data store 160 is shown in FIG. 1, the data graph processing system 100 may include two, three, or more similar instances of the data store 160. Moreover, the network 150 may provide access to other data stores, similar to data store 160 that are located outside of the data graph processing system 100, in some embodiments.

FIG. 2 depicts an example of a data graph 200, according to an embodiment. The data graph 200 generally corresponds to an enterprise organization, business, work group, or other suitable domain, in various examples. The data graph 200 has nodes representing entities associated with the domain and edges between nodes representing relationships among the entities. In some examples, the data graph 200 is a data and interaction graph that contains information related to interactions with entities, for example, where the interactions are represented by the edges between nodes. Examples of the entities may include documents (e.g., spreadsheets, text documents, videos, images, etc.), files, users (e.g., employees, clients, vendors), emails, messages, meetings, organizational groups (e.g., accounting, research and development, etc.), topics, topic-based groups (e.g., users that have searched for or created documents associated with a topic), or other suitable entities. The relationships between entities may include document authorship or modification by a user (or group), document sharing by a user, meeting invites or attendance by a user, linked data between documents, comments and/or replies to comments, emails and email replies, or other suitable relationships. In some scenarios, multiple different relationships are present between two or more nodes. For example, a user may modify a slideshow (modification relationship), present the slideshow (presenter relationship), share the slideshow (sharing relationship), etc.

In the example shown in FIG. 2, the data graph 200 includes user nodes 220, 240, 250, and 265, slideshow node 230, comment node 260, text document node 270, and spreadsheet node 275. The user node 220 may represent a first employee of an enterprise organization, while the user node 240 represents a second employee that is the first employee's manager. In other words, the user node 220 and the user node 240 share a manager relationship represented by an edge in the data graph 200. The slideshow node 230 may represent a PowerPoint presentation that the first employee has previously presented so that the user node 220 and the slideshow node 230 share a presenter relationship. The user node 250 may represent a third employee that attended a meeting with the first employee so that the user node 220 and the user node 250 share a meeting relationship.

Some nodes within the data graph 200 may not be directly related to another, but are related through one, two, three, or more intermediate nodes. For example, the comment node 260 shares a viewed relationship with the user node 220 (e.g., the first employee has viewed a comment represented by the comment node 260) while the user node 265 represents a fourth employee who has authored the comment (e.g., the fourth employee has an authorship relationship with the comment node 260). As another example, the text document node 270 may represent a text document that contains a link to data within a spreadsheet represented by the spreadsheet node 275 (e.g., a link relationship between the text document node 270 and the spreadsheet node 275). Although only a small number of nodes are shown in FIG. 2 for clarity, it will be appreciated that an enterprise organization with hundreds or thousands of employees and their associated documents, meeting calendars, etc. may have millions of nodes with billions of edges for relationships among those nodes.

In various examples, nodes of the data graph 200 include content, metadata, or both content and metadata. For example, content of the slideshow node 230 may include text, images, and animations that appear within the corresponding slideshow. Metadata may include a number of times that the slideshow has been presented, viewed, or modified, a file size or slide count, times when the slideshow was accessed, a duration of time since a most recent access, etc. Some nodes of the data graph 200 may contain metadata that is not present within other nodes.

The node processor 112 may generate embeddings for nodes of the data graph 200 as encoded bit vectors, single or multi-dimensional arrays, or other suitable data structures in various examples. As one example, the node processor 112 generates an embedding for a node as a 512-bit vector, such as a vector having sixteen elements (i.e., n=16 dimensions), each element being a 32-bit float value or integer value. In other examples, the embedding is a vector having a size larger or smaller than 512 bits. In some examples, the vector has different element sizes, such as a first element that is 32 bits, a second element that is 20 bits, a third element that is 16 bits, etc.

Generally, a format or structure of the embedding is selected to be a more compact format that is more easily processed by general purpose processors. In this way, a personal computer or even smartphone may process embeddings and provide graph data in real-time or near real-time. In some examples, the use of embeddings by the node processor 112 enables faster searching and suggestions generation because the data graph 200 does not need to be accessed or searched in its entirety. For example, the node processor 112 may generate embeddings for nodes of the data graph 200 and then compare the embeddings when performing a search without needing to “walk the graph” or search for keywords within content of the nodes each time a recommendation is needed.

In some examples, text features of a node are tokenized and indexed before embeddings are generated. For example, a node containing a vector of text features of [“Exchange”,“Forest”,“Down”,“Exchange”] is tokenized and indexed to [4,100,200,4]. For tokenization, the node processor 112 may create a word-to-integer index dictionary for each unique text feature.

In some examples, the node processor 112 generates embeddings for each node of the data graph 200. For example, when the data graph 200 includes 1000 nodes, then the node processor 112 generates 1000 embeddings with one embedding per node. These 1000 embeddings may be referred to as a set of embeddings. In some examples, embeddings of the set of embeddings may correspond to different types of entities within an enterprise organization, for example, document types, user types, meeting types, etc.

As another example, when the data graph 200 includes 1000 nodes, the node processor 112 may generate 3000 embeddings with three embeddings per node. In this example, each embedding for a particular node may correspond to a set of embeddings for the 1000 nodes and the 3000 embeddings may be referred to as a plurality of sets of embeddings. In one example, each set of the plurality may correspond to a particular granularity, as described herein. For example, a first set of the plurality of sets of embeddings is generated for a first user within an enterprise organization and a second set of the plurality of sets of embeddings is generated for a first group of users within the enterprise organization.

In other examples, the node processor 112 generates embeddings for only predetermined types of nodes, such as only user nodes, or only document, email, and user nodes. Advantageously, the node processor 112 may generate the embeddings offline and store the embeddings for use at a later time. Moreover, since the embeddings have a reduced size (e.g., 512 bits), embeddings for large data graphs with even millions of nodes are more easily generated and processed.

In some examples, the node processor 112 generates multiple embeddings for at least some nodes at different levels of granularity of the data graph 200. In some scenarios, embeddings generated from a group level or enterprise level are more insightful than at a user level. For example, when a user is a new employee who has not had many interactions with documents that are common to that user's department (e.g., financial documents for the accounting department), the user may not have sufficient relationships with commonly used financial reports for a graph walk to provide useful results. In this scenario, embeddings for a financial report generated from the point of view of the accounting department may provide search results or suggestions with improved accuracy. For example, a group of nodes or a virtual node that represents employees of the accounting department may have many more relationships with a fourth quarter financial report. Accordingly, when the new employee of the accounting department performs a search for financial reports, the node processor 112 may identify the fourth quarter financial report not on the basis of the new user, but based on the relationships of the other employees within the accounting department. In this way, the node processor 112 may provide different embeddings for a node that are specific to a particular user, a particular group, a particular organization, or other level of granularity using data that is specific to the level (e.g., search history that is specific to the user, or generalized for a group). In some examples, multiple instances of the data graph 200 are maintained, for example, one instance for each level of granularity: a user level data graph, a group level data graph, an enterprise level data graph, etc. In these examples, each instance contains nodes and edges (e.g., representing data and relationships) for only a particular user, group, enterprise, etc. In other words, each user may have a separate instance of the data graph 200 that is specific to that user.

As another example, the node processor 112 may generate multiple embeddings for a node by temporarily pruning (e.g., hiding or ignoring) at least some nodes or edges from the data graph 200. For example, a document-document search may be made faster, less memory intensive, or having improved relevance by pruning all non-document nodes from the data graph 200 before generating an embedding corresponding to a document search type. In other examples, the node processor 112 may perform a graph projection for the data graph 200 to obtain an instance of the data graph 200, and thereby embeddings, that are specific to a particular type of search. In this way, some embeddings may be generated that are specific to a particular task or type of search (e.g., documents to be attached to an email with a particular title), while other embeddings are more applicable to general purpose searches (e.g., a user performing a general document search on a topic). In other examples, the node processor 112 may generate embeddings by temporarily adding edges between nodes, for example, by adding edges between documents that have at least one user in common, were created by a VIP user, or have other suitable criteria. In some examples, the node processor 112 performs pruning to obtain a data graph that is specific to a user, a group, an enterprise, etc. For example, the node processor 112 may prune nodes and edges that are not associated with a particular user to obtain an instance of the data graph 200 for that user.

Generally, the node processor 112 generates embeddings having a same size for nodes of the data graph 200, even for nodes of different types. In other words, the user node 220 has an embedding that is the same size as the slideshow node 230, the comment node 260, etc. Accordingly, the node processor 112 may readily compare nodes of different types. In some examples, the node processor 112 generates embeddings having different sizes or structures at different levels of granularity. For example, the node processor 112 may generate a 512-bit vector for a user-level embedding, but a 768-bit vector for a group-level embedding (e.g., where there are fewer nodes available due to grouping of nodes). In scenarios where embeddings have different sizes, the node processor 112 may compress a higher-order embedding (e.g., the 768-bit vector) into a lower-order embedding (e.g., the 512-bit vector), for example, using a projection function, hash function, or other suitable process, to allow for a direct comparison between nodes without having to compute a separate embedding at a different granularity level.

In some examples, each node of the data graph 200 is associated with a set of embeddings at different granularity levels or “slices” of the data graph. As a first example, the set of embeddings may include a first embedding based on a user-level slice which represents all the entity interactions and knowledge at a user level. These user-level embeddings are per-user and represent deeper level of user personalization, but may not always have context of a broader perspective. As a second example, the set of embeddings may include a second embedding based on a group-level slice which represents group level entity relations (e.g., relationships among departments instead of individuals). As a third example, the set of embeddings may include a third embedding based on an enterprise-level slice (e.g., the data graph 200 in its entirety). Generally, the second embedding based on the group-level slice may be more scalable than the third embedding based on the enterprise-level slice. As described above, the node processor 112 may prune the data graph 200 to obtain an instance of the data graph 200 that is specific to a desired granularity level before generating a corresponding embedding for the desired granularity level.

The node processor 112 may be configured to generate multiple embeddings for a same node at different times, for example, to maintain accuracy as new relationships are created or modified. For example, the node processor 112 may update an embedding for a node at every day, every week, or other suitable interval to include new nodes and/or edges (e.g., new emails, topics, interactions, relationships). As another example, the node processor 112 may generate the embeddings in response to one or more triggers, such as changing a job title associated with a user node, changing a department, adding one or more new contacts, or other changes to the data graph 200. When embeddings are generated at different times, the node processor 112 may be configured to generate embeddings as a background task.

The node processor 112 may generate embeddings using fast random projections (FastRP), graph neural networks, random walks, Node2Vec, or other suitable algorithms for embedding generation. In some examples, the node processor 112 generates embeddings based on the Johnson-Lindenstrauss lemma, wherein a set of points in a high-dimensional space can be embedded into a space of much lower dimension in such a way that distances between the points are nearly preserved. In one such example, the node processor 112 generates embeddings by determining a weighted sum of projections for different degrees of a graph transition matrix. In some examples, the node processor 112 divides the data graph 200 into sparsely connected sub-graphs and generates embeddings using a distributed processing system with parameter sharing among processing nodes.

In some examples, the node processor 112 is configured to pre-compute embeddings, sets of embeddings, or pluralities of sets of embeddings so that a set of embeddings may be selected at a later time in response to a general purpose requests, specific requests, or any suitable request for comparison. In this way, real-time or near-real-time searches may be performed by selecting an appropriate set of embeddings and identifying embeddings from the set that are adjacent to a search embedding. In some examples, embeddings are pre-computed for selection in response to different request types. In other words, a single “multi-purpose” set of embeddings is pre-computed for searches based on documents, users, meetings, etc. In other examples, a set of embeddings is pre-computed for selection in response to a particular request type. In other words, a set of embeddings is pre-computed for use in response to a user search, or in response to a document search, etc.

The node processor 112 is configured to determine a confidence value for similarity between embeddings. For example, the node processor 112 may determine a relatively high confidence value (e.g., 0.98) when the embeddings for two nodes are very similar and relatively low confidence value (e.g., 0.2) when the embeddings are not similar. Generally, a high confidence value above a predetermined threshold (e.g., 0.7 or more) indicates that the corresponding nodes have, or should have, a relationship. The node processor 112 is configured to calculate a squared Euclidean distance between the embeddings as the confidence value, in some examples. In other examples, the node processor 112 determines a different distance metric for comparing the embeddings, for example, a Manhattan distance, a Minkowski distance, or Hamming distance.

In some examples, the neural network model 162 is trained through contrastive loss to learn embeddings for nodes of the data graph 200. Generally, the embeddings are used to calculate a Euclidean distance and nodes that share one or more relationships have embeddings close in Euclidean distance, while nodes without existing relationships are farther apart. In some embodiments, the types of relationships (e.g., edges between nodes) are weighted differently, for example, so that an authorship relationship between a first user and a first document and an authorship relationship between the first user and a second document results in embeddings for the first document and second document that are closer than documents with a view relationship.

When training the neural network model 162, in some examples, the node processor 112 generates a first training set from the data graph 200 by labeling documents that have been shared in the same email or meeting as relevant to each other. In another example, the node processor 112 generates a second training set from the data graph 200 by labeling a top five most frequently contacted users for a given user as relevant to the given user. In some examples, additional edges are added between user nodes to increase weights when a user has more than predetermined number of contacts per day with another user, when that user is on speed dial, etc.

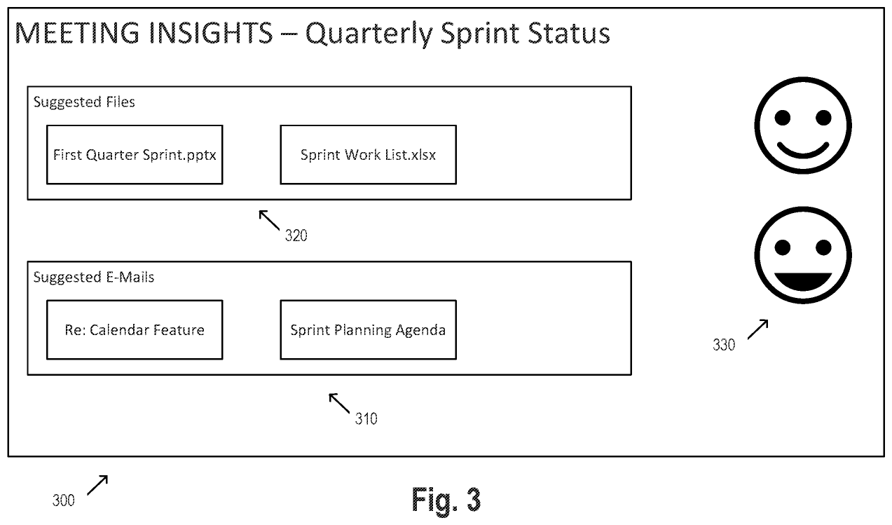

FIG. 3 depicts an example of a graphical user interface 300 for providing graph data, according to an embodiment. Generally, the node processor 112 may be configured to identify nodes that are similar, related, or adjacent to a given node or to a search query. The node processor 112 may identify the nodes either in response to a request from a user or automatically based on a suitable trigger (e.g., opening a user interface menu item, receiving an email, saving a document), in various examples. When using a node as a starting point, such as a node corresponding to a document displayed on a user interface, the node processor 112 uses a previously generated embedding (e.g., a user-level embedding) as a search embedding to perform a search for related nodes. When using a request or query as a starting point, the node processor 112 may generate the search embedding for the request based on the content of the request (e.g., based on key phrases within the request). The node processor 112 may then identify embeddings (from the set of previously generated embeddings for the data graph 200) that are adjacent to the search embedding based on a suitable distance metric.

In the example shown in FIG. 3, the graphical user interface 300 includes a meeting insights “tile” or pop-up for an email node corresponding to an emailed invite to a quarterly sprint status meeting. The graphical user interface 300 may include suggested emails 310, suggested files 320, and/or suggested users 330. To identify the suggested emails 310, the node processor 112 may select a set of embeddings for the data graph 200 that correspond to an email-only level of granularity (e.g., embeddings created while ignoring non-email nodes) and identify other embeddings that are adjacent to the embedding of the email node. To identify the suggested files 320 and the suggested users 330, the node processor 112 may select a set of embeddings for the data graph 200 that correspond to a document and user level of granularity (e.g., embeddings created using only documents and users) and identify other embeddings that are adjacent to the embedding of the email node.

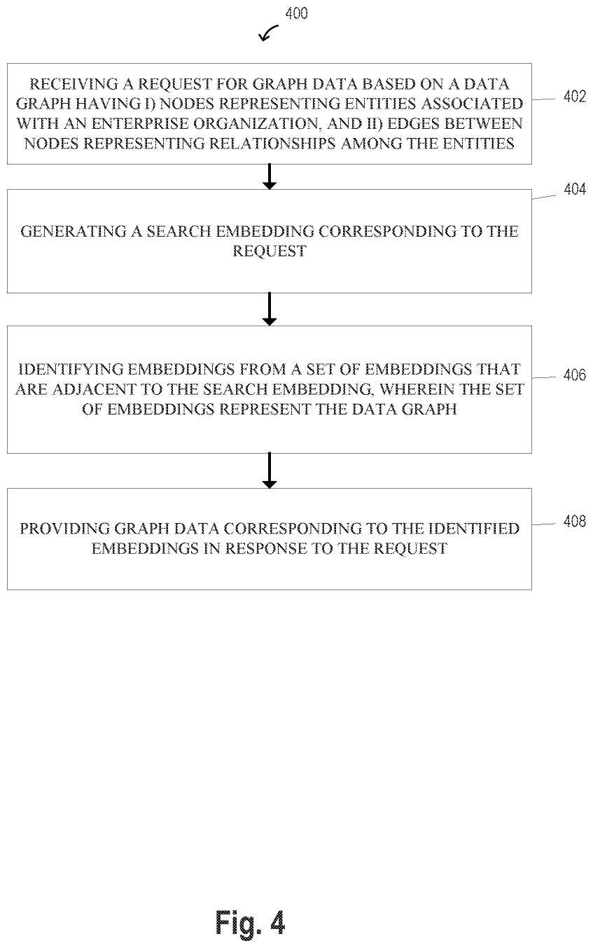

FIG. 4 shows a flowchart of an example method 400 of providing graph data, according to an example embodiment. Technical processes shown in these figures will be performed automatically unless otherwise indicated. In any given example, some steps of a process may be repeated, perhaps with different parameters or data to operate on. Steps in an example may also be performed in a different order than the top-to-bottom order that is laid out in FIG. 4. Steps may be performed serially, in a partially overlapping manner, or fully in parallel. Thus, the order in which steps of method 400 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. The steps of FIG. 4 may be performed by the computing device 110 (e.g., via the node processor 112), the computing device 120 (via the node processor 122), or other suitable computing device.

Method 400 begins with step 402. At step 402, a request for graph data based on a data graph is received, where the data graph has nodes representing entities associated with an enterprise organization, and edges between nodes representing relationships among the entities. The data graph corresponds to the data graph 164 or the data graph 200, in some examples. The entities may include users, documents, emails, meetings, conversations, or other suitable entities associated with the enterprise organization, in various examples. The relationships may include document authorship by a user, document modification by a user, document sharing by a user, meeting invites from a user, linked data between documents, email sending, and email replying, or other suitable relationships, in various examples. The request for graph data may be a request for nodes of the data graph that are related to a search query, in some examples. The request for graph data may be a request for edges between selected nodes of the data graph and the graph data corresponds to predicted relationships between the selected nodes, in some examples. As one example, a predicted relationship for a comment may include a list of users who are likely to view the comment. As another example, a predicted relationship for a document may include a list of documents from which content may be copied.

At step 404, a search embedding corresponding to the request is generated. For example, the node processor 112 generates a search embedding (e.g., a 512-bit vector) that corresponds to the request. In some examples, the request is associated with a key phrase, such as “documents for fourth quarter finance presentation.” In other examples, the request is associated with a document, user, email, or other suitable entity that is selected by a user. In some examples, each embedding of the search embedding and the set of embeddings is a vector having an integer n dimensions. In some examples, each embedding of the set of embeddings corresponds to a node of the data graph. In some examples, embeddings of the set of embeddings correspond to different types of entities within the enterprise organization.

At step 406, embeddings are identified, from a set of embeddings, that are adjacent to the search embedding. The set of embeddings represent the data graph, for example, the data graph 200, and are based on different levels of granularity of the data graph.

At step 408, graph data corresponding to the identified embeddings are provided in response to the request. For example, embeddings that are adjacent to the search embedding (and their corresponding nodes) are identified and the corresponding entities (e.g., documents, emails, users) are provided.

In some examples, the method 400 further includes selecting the set of embeddings from a plurality of sets of embeddings, wherein each set of the plurality of sets of embeddings is generated for the data graph at different levels of granularity of the data graph. In one such example, a first set of the plurality of sets of embeddings is generated for a first user within the enterprise organization and a second set of the plurality of sets of embeddings is generated for a first group of users within the enterprise organization. In another example, the plurality of sets of embeddings are a first plurality of sets of embeddings that is specific to the first user.

In some examples, the method 400 further includes pre-computing the embeddings of the plurality of sets of embeddings before receiving the request.

In some examples, generating the search embedding and identifying the embeddings are performed in real-time.

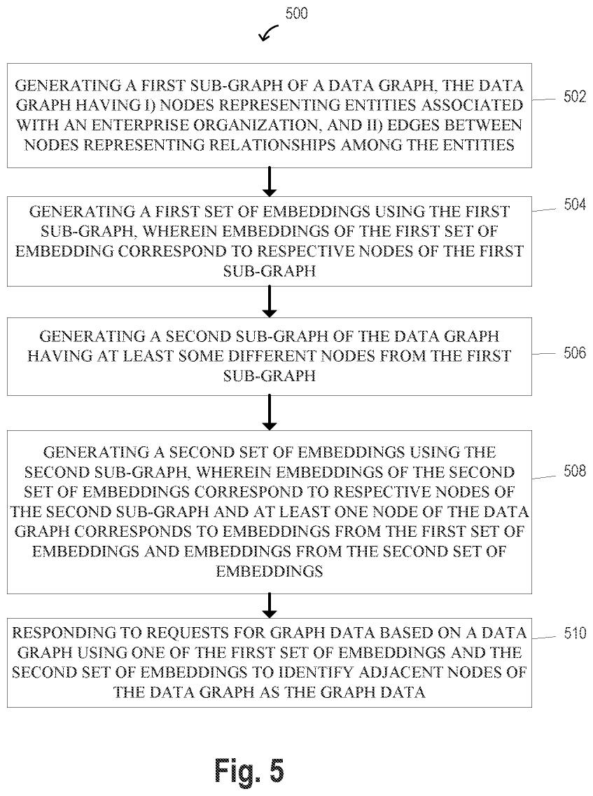

FIG. 5 shows a flowchart of an example method 500 of providing graph data, according to an example embodiment. Technical processes shown in these figures will be performed automatically unless otherwise indicated. In any given example, some steps of a process may be repeated, perhaps with different parameters or data to operate on. Steps in an embodiment may also be performed in a different order than the top-to-bottom order that is laid out in FIG. 5. Steps may be performed serially, in a partially overlapping manner, or fully in parallel. Thus, the order in which steps of method 500 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. The steps of FIG. 5 may be performed by the computing device 110 (e.g., via the node processor 112), the computing device 120 (via the node processor 122), or other suitable computing device.

Method 500 begins with step 502. At step 502, a first sub-graph of a data graph is generated where the data graph has i) nodes representing entities associated with an enterprise organization, and ii) edges between nodes representing relationships among the entities. Generating the first sub-graph may include pruning at least some first nodes from the data graph to generate the first sub-graph. The first sub-graph may correspond to only the document nodes of the data graph 200, for example. The first sub-graph is a horizontal sub-graph, vertical sub-graph, or a combination of horizontal and vertical sub-graphs, in various examples.

At step 504, a first set of embeddings are generated using the first sub-graph, wherein embeddings of the first set of embedding correspond to respective nodes of the first sub-graph.

At step 506, a second sub-graph of the data graph is generated having at least some different nodes from the first sub-graph. Generating the second sub-graph may include pruning at least some second nodes from the data graph to generate the second sub-graph. The second sub-graph may correspond to only the user nodes of the data graph 200, for example. The second sub-graph is a horizontal sub-graph, vertical sub-graph, or a combination of horizontal and vertical sub-graphs, in various examples.

At step 508, a second set of embeddings is generated using the second sub-graph, wherein embeddings of the second set of embeddings correspond to respective nodes of the second sub-graph and at least one node of the data graph corresponds to embeddings from the first set of embeddings and embeddings from the second set of embeddings.

At step 510, requests for graph data are responded to based on a data graph using one of the first set of embeddings and the second set of embeddings to identify adjacent nodes of the data graph as the graph data.

In some examples, the method 500 further includes providing one or more embeddings of the first and second set of embeddings to a remote computing device via an application protocol interface (API). For example, the node processor 112 may provide a set of embeddings for a user to the remote computing device via the API so that the remote computing device may perform a query. Advantageously, the node processor 112 may provide the embeddings, which represent the relationships among nodes within the enterprise organization, to the remote computing device without revealing the relationships themselves, which may constitute a breach of privacy to a user or organization. In some examples, the node processor 112 enforces access controls to limit access to one or more sets of embeddings for privacy and/or security reasons.

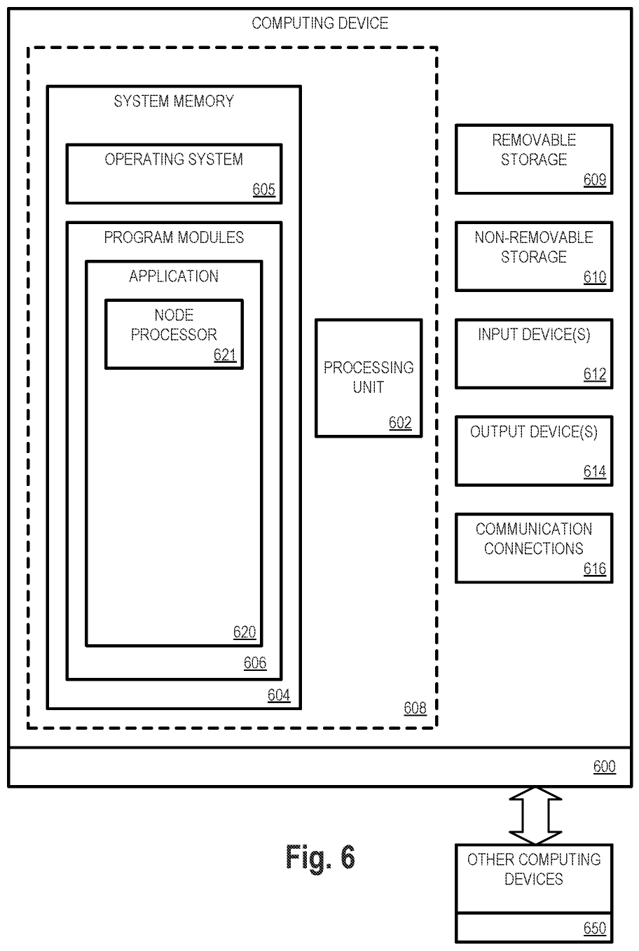

FIGS. 6, 7, and 8 and the associated descriptions provide a discussion of a variety of operating environments in which aspects of the disclosure may be practiced. However, the devices and systems illustrated and discussed with respect to FIGS. 6, 7, and 8 are for purposes of example and illustration and are not limiting of a vast number of computing device configurations that may be utilized for practicing aspects of the disclosure, as described herein.

FIG. 6 is a block diagram illustrating physical components (e.g., hardware) of a computing device 600 with which aspects of the disclosure may be practiced. The computing device components described below may have computer executable instructions for implementing a node processor application 620 on a computing device (e.g., computing device 110), including computer executable instructions for node processor application 620 that can be executed to implement the methods disclosed herein. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program modules 606 suitable for running node processor application 620, such as one or more components with regard to FIG. 1, and, in particular, node processor 621 (e.g., corresponding to node processor 112 or node processor 122).

The operating system 605, for example, may be suitable for controlling the operation of the computing device 600. Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., node processor application 620) may perform processes including, but not limited to, the aspects, as described herein. Other program modules that may be used in accordance with aspects of the present disclosure, and in particular for providing graph data, may include node processor 621.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

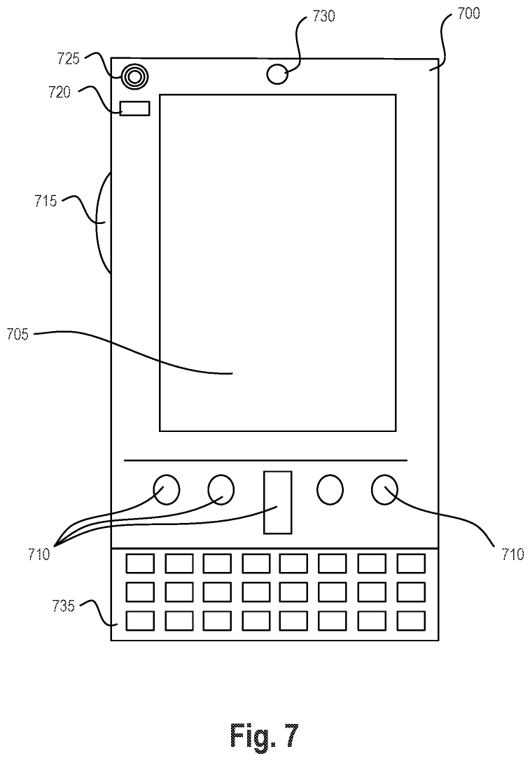

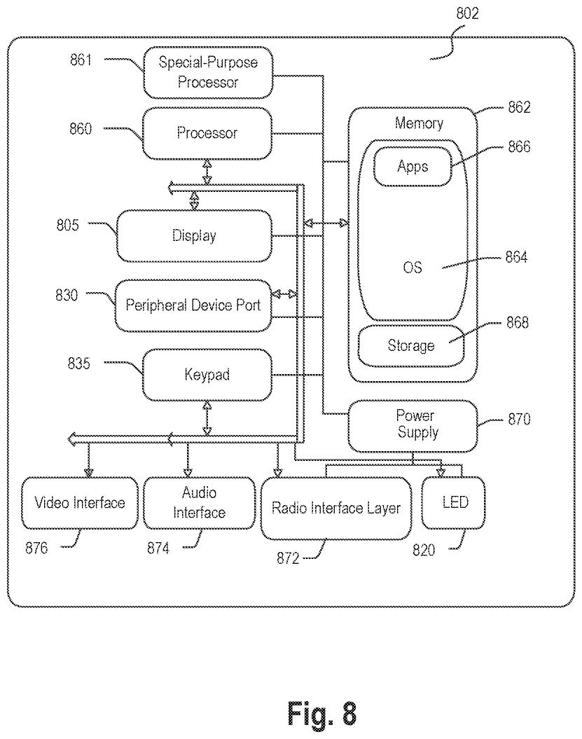

FIGS. 7 and 8 illustrate a mobile computing device 700, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 7, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative aspects, mobile computing device 700 may incorporate more or less input elements. For example, the display 705 may not be a touch screen in some embodiments. In yet another alternative embodiment, the mobile computing device 700 is a portable phone system, such as a cellular phone. The mobile computing device 700 may include a front-facing camera 730. The mobile computing device 700 may also include an optional keypad 735. Optional keypad 735 may be a physical keypad or a “soft” keypad generated on the touch screen display. In various embodiments, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 8 is a block diagram illustrating the architecture of one aspect of a mobile computing device. That is, the mobile computing device 700 can incorporate a system (e.g., an architecture) 802 to implement some aspects. In one embodiment, the system 802 is implemented as a “smart phone” capable of running one or more applications (e.g., browser, e-mail, calendaring, contact managers, messaging clients, games, and media clients/players). In some aspects, the system 802 is integrated as a computing device, such as an integrated personal digital assistant (PDA) and wireless phone. The system 802 may include a display 805 (analogous to display 705), such as a touch-screen display or other suitable user interface. The system 802 may also include an optional keypad 835 (analogous to keypad 735) and one or more peripheral device ports 830, such as input and/or output ports for audio, video, control signals, or other suitable signals.

The system 802 may include a processor 860 coupled to memory 862, in some examples. The system 802 may also include a special-purpose processor 861, such as a neural network processor. One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as email or other messages used by an email application, and the like. A synchronization application (not shown) also resides on the system 802 and is programmed to interact with a corresponding synchronization application resident on a host computer to keep the information stored in the non-volatile storage area 868 synchronized with corresponding information stored at the host computer.

The system 802 has a power supply 870, which may be implemented as one or more batteries. The power supply 870 may further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via an audio transducer 725 (e.g., audio transducer 725 illustrated in FIG. 7). In the illustrated embodiment, the visual indicator 820 is a light emitting diode (LED) and the audio transducer 725 may be a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 725, the audio interface 874 may also be coupled to a microphone to receive audible input, such as to facilitate a telephone conversation. In accordance with embodiments of the present disclosure, the microphone may also serve as an audio sensor to facilitate control of notifications, as will be described below. The system 802 may further include a video interface 876 that enables an operation of peripheral device port 830 (e.g., for an on-board camera) to record still images, video stream, and the like.

A mobile computing device 700 implementing the system 802 may have additional features or functionality. For example, the mobile computing device 700 may also include additional data storage devices (removable and/or non-removable) such as, magnetic disks, optical disks, or tape. Such additional storage is illustrated in FIG. 8 by the non-volatile storage area 868.

Data/information generated or captured by the mobile computing device 700 and stored via the system 802 may be stored locally on the mobile computing device 700, as described above, or the data may be stored on any number of storage media that may be accessed by the device via the radio interface layer 872 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 872 or via a distributed computing network. Similarly, such data/information may be readily transferred between computing devices for storage and use according to well-known data/information transfer and storage means, including electronic mail and collaborative data/information sharing systems.

As should be appreciated, FIGS. 7 and 8 are described for purposes of illustrating the present methods and systems and is not intended to limit the disclosure to a particular sequence of steps or a particular combination of hardware or software components.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A computer-implemented method of providing graph data, the method comprising:
receiving a request for graph data based on a data graph having i) nodes representing entities associated with an enterprise organization, and ii) edges between nodes representing relationships among the entities;
generating a search embedding corresponding to the request;
identifying embeddings from a set of embeddings that are adjacent to the search embedding, wherein the set of embeddings represent the data graph; and
providing graph data corresponding to the identified embeddings in response to the request.

2. The method of claim 1, wherein the entities include users, documents, emails, meetings, and conversations associated with the enterprise organization.

3. The method of claim 1, wherein the relationships include document authorship, document modification, document sharing, meeting invites, linked data between documents, email sending, and email replying.

4. The method of claim 1, wherein the request for graph data is a request for nodes of the data graph that are related to a search query.

5. The method of claim 1, wherein the request for graph data is a request for edges between selected nodes of the data graph and the graph data corresponds to predicted relationships between the selected nodes.

6. The method of claim 1, wherein each embedding of the search embedding and the set of embeddings is a vector having an integer n dimensions.

7. The method of claim 6, wherein each embedding of the set of embeddings corresponds to a node of the data graph.

8. The method of claim 7, wherein embeddings of the set of embeddings correspond to different types of entities within the enterprise organization.

9. The method of claim 1, the method further comprising selecting the set of embeddings from a plurality of sets of embeddings, wherein each set of the plurality of sets of embeddings is generated for the data graph at different levels of granularity of the data graph.

10. The method of claim 9, wherein a first set of the plurality of sets of embeddings is generated for a first user within the enterprise organization and a second set of the plurality of sets of embeddings is generated for a first group of users within the enterprise organization.

11. The method of claim 9, the method further comprising pre-computing the plurality of sets of embeddings before receiving the request; and
wherein at least one set of embeddings is pre-computed for selection in response to different request types.

12. The method of claim 9, the method further comprising pre-computing the plurality of sets of embeddings before receiving the request; and
wherein at least one set of embeddings is pre-computed for selection in response to a particular request type.

13. The method of claim 9, wherein the plurality of sets of embeddings are a first plurality of sets of embeddings that is specific to the first user.

14. A system for providing graph data, the system comprising:
a node processor configured to receive requests for graph data;
wherein the node processor is configured to:
generate a first sub-graph of a data graph, the data graph having i) nodes representing entities associated with an enterprise organization, and ii) edges between nodes representing relationships among the entities;
generate a first set of embeddings using the first sub-graph, wherein embeddings of the first set of embedding correspond to respective nodes of the first sub-graph;
generate a second sub-graph of the data graph having at least some different nodes from the first sub-graph;
generate a second set of embeddings using the second sub-graph, wherein embeddings of the second set of embeddings correspond to respective nodes of the second sub-graph and at least one node of the data graph corresponds to embeddings from the first set of embeddings and embeddings from the second set of embeddings; and
respond to requests for graph data based on a data graph using one of the first set of embeddings and the second set of embeddings to identify adjacent nodes of the data graph as the graph data.

15. The system of claim 14, wherein the node processor is configured to:
generate the first sub-graph by pruning at least some first nodes from the data graph to generate the first sub-graph; and
generate the second sub-graph by pruning at least some second nodes from the data graph to generate the second sub-graph.

16. The system of claim 15, wherein the first sub-graph is a horizontal sub-graph, vertical sub-graph, or a combination of horizontal and vertical sub-graphs.

17. The system of claim 14, wherein one or more embeddings of the first and second set of embeddings are provided to a remote computing device via an application protocol interface.

18. A computer-implemented method for providing graph data, the method comprising:
generating a first sub-graph of a data graph, the data graph having i) nodes representing entities associated with an enterprise organization, and ii) edges between nodes representing relationships among the entities;
generating a first set of embeddings using the first sub-graph, wherein embeddings of the first set of embedding correspond to respective nodes of the first sub-graph;
generating a second sub-graph of the data graph having at least some different nodes from the first sub-graph;
generating a second set of embeddings using the second sub-graph, wherein embeddings of the second set of embeddings correspond to respective nodes of the second sub-graph and at least one node of the data graph corresponds to embeddings from the first set of embeddings and embeddings from the second set of embeddings; and
responding to requests for graph data based on the data graph using one of the first set of embeddings and the second set of embeddings to identify adjacent nodes of the data graph as the graph data.

19. The method of claim 18, wherein:
generating the first sub-graph comprises pruning at least some first nodes from the data graph to generate the first sub-graph; and
generating the second sub-graph comprises pruning at least some second nodes from the data graph to generate the second sub-graph.

20. The method of claim 18, wherein the first sub-graph is a horizontal sub-graph, vertical sub-graph, or a combination of horizontal and vertical sub-graphs.
